(19) United States
(12) Patent Application Publication
(10) Pub. No.: US 2008/0099170 A1
(43) Pub. Date: May 1, 2008

(54) PROCESS OF MAKING WET-MICROCONTRACTED PAPER

(75) Inventors: Ward William Ostendorf, West Chester, OH (US); Steven Anthony Horenziak, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/924,747

(22) Filed: Oct. 26, 2007

Related U.S. Application Data
(60) Provisional application No. 60/855,499, filed on Oct. 31, 2006.

(51) Int. Cl. B31F 1/12; B31F 1/14

(52) U.S. Cl. 162/112

(57) ABSTRACT

A process of making a wet-microcontracted fibrous structure product comprising the steps of: forming an embryonic web and forwarding the web at a first velocity on a carrier fabric to a transfer zone having a transfer/imprinting fabric; non-compressively removing water from the web; transferring the web to the transfer/imprinting fabric in the transfer zone without precipitating substantial densification of the web; forwarding, at a second velocity, the transfer/imprinting fabric along a looped path in contacting relation with a transfer head disposed at the transfer zone, the second velocity being from about 5% to about 40% slower than the first velocity; adhesively securing the web to a drying cylinder having a third velocity; drying the web without overall mechanical compaction of the web; creping the web from the drying cylinder with a doctor blade, the doctor blade having an impact angle of from about 90 degrees to about 130 degrees; and reeling the web at a forth velocity that is faster than the third velocity of the drying cylinder.

### CROSS REFERENCE TO RELATED APPLICATION

This application claims the benefit of U.S. Provisional Application No. 60/855,499 filed Oct. 31, 2006.

### FIELD OF THE INVENTION

This invention pertains to a process of making fibrous structure products having high bulk and high liquid absorbency. More specifically this invention pertains to a process for making such fibrous structure products which includes substantially foreshortening a wet-laid paper web in the wet end of a papermaking machine under such conditions that the foreshortening does not precipitate substantial compaction or densification of the web.

### BACKGROUND OF THE INVENTION

Paper products are a staple of every day life. Paper products are used as bath tissue, facial tissue, paper toweling, napkins, etc. Typically, such paper products are made by depositing an aqueous slurry of cellulosic fibers from a headbox. The aqueous carrier is removed, leaving the cellulosic fibers to form an embryonic web which is dried to form a paper sheet. The cellulosic fibers may be dried with press felts, by through air drying or by any other suitable means. The large demand for such paper products has created a demand for improved versions of these products.

Important characteristics of these products include strength, softness, bulk, and/or absorbency. Strength is the ability of a paper web to retain its physical integrity during use especially when wet. Softness is the pleasing tactile sensation consumers perceive when they use the paper for its intended purposes. Absorbency is the characteristic of the paper that allows the paper to take up and retain fluids, particularly water and aqueous solutions and suspensions.

The process of the present invention improves these product characteristics through the optimization of: the velocity of the carrier fabric relative to the transfer/imprinting fabric, the transfer/imprinting fabric, the velocity of the reel relative to the dryer/creping cylinder, and/or the optimization of the creping blade impact angle. The careful control of these parameters, results in a fibrous structure product having high bulk, wet strength substantially higher from comparably extensible dry-creped paper, improved absorbency, and/or acceptable tensile. Careful optimization of these parameters is important since wet-microcontracting may precipitate lower tensile strength and less softness, and adjusting the creping blade impact angle may also degrade tensile.

### BRIEF DESCRIPTION OF THE DRAWINGS

While the specification concludes with claims that particularly point out and distinctly claim the present invention, it is believed that the present invention will be understood better from the following description of embodiments, taken in conjunction with the accompanying drawings, in which like reference numerals identify identical elements.

Without intending to limit the invention, embodiments are described in more detail below:

FIG. 1 is a schematic side elevational view of a papermaking machine with a transfer zone for use in the practice of the present invention.

FIG. 2 is a schematic, side elevational view of a C-wrap, twin-wire-former (TWF) type papermaking machine for use in the practice of the present invention.

FIG. 3 is a schematic, side elevational view of another papermaking machine for use in the practice of the present invention.

FIG. 4 is a fragmentary, enlarged scale, side elevational view of the creping-drying cylinder and creping blade portion of the papermaking machine shown in FIG. 1.

FIGS. 5 and 6 are fragmentary plan views of an embodiment of a forming wire/carrier fabric and transfer/imprinting fabric, respectively, for use in the papermaking machine shown in FIG. 1.

FIG. 7 is a fragmentary top plan view of a transfer/imprinting fabric, the framework comprising a first layer comprising a continuous patterned network defining a plurality of discrete deflection conduits and the second layer comprising discrete protuberances, for use in the present invention.

FIG. 8 is an offset vertical sectional view of the transfer/imprinting fabric of FIG. 7 taken along lines 8-8, where the second layer completely penetrates at least some of the reinforcing element.

FIG. 9 is a fragmentary top plan view of a transfer/imprinting fabric, the framework comprising a first layer comprising a semi-continuous patterned network defining a plurality of semi-continuous deflection conduits and the second layer comprising discrete protuberances for use according to the present invention.

FIG. 10 is an offset vertical sectional view of the transfer/imprinting fabric of FIG. 9 taken along lines 10-10, where the second layer completely penetrates at least some of the reinforcing element.

### SUMMARY OF THE INVENTION

The present invention, for example, relates to a process of making a wet-microcontracted fibrous structure product having high bulk and absorbency, comprising the steps of:

forming an embryonic web from an aqueous fibrous papermaking furnish;

forwarding the web at a first velocity on a carrier fabric to a transfer zone having a transfer/imprinting fabric;

non-compressively removing water from the web to a fiber consistency of from about 10% to about 30%, immediately prior to reaching the transfer zone to enable the web to be transferred to the transfer/imprinting fabric at the transfer zone;

transferring the web to the transfer/imprinting fabric in the transfer zone without precipitating substantial densification of the web;

forwarding, at a second velocity, the transfer/imprinting fabric along a looped path in contacting relation with a transfer head disposed at the transfer zone, the second velocity being from about 5% to about 40% slower than the first velocity;

adhesively securing the web to a drying cylinder having a third velocity;

drying the web without overall mechanical compaction of the web;

creping the web from the drying cylinder with a doctor blade, the doctor blade having an impact angle of from about 90 degrees to about 130 degrees; and

reeling the web at a fourth velocity that is faster than the third velocity of the drying cylinder.

### DETAILED DESCRIPTION OF THE INVENTION

### Definitions

As used herein, “paper product” refers to any formed, fibrous structure products, traditionally, but not necessarily, comprising cellulose fibers. In one embodiment, the paper products of the present invention include tissue-towel paper products.

A “tissue-towel paper product” refers to products comprising paper tissue or paper towel technology in general, including, but not limited to, conventional felt-pressed or conventional wet-pressed fibrous structure product, through-air-dried product pattern densified fibrous structure product, starch substrates, and high bulk, uncompacted fibrous structure product. Non-limiting examples of tissue-towel paper products include disposable or reusable, toweling, facial tissue, bath tissue, table napkins, placemats, wipes, and the like.

“Ply” or “Plies”, as used herein, means an individual fibrous structure or sheet of fibrous structure, optionally to be disposed in a substantially contiguous, face-to-face relationship with other plies, forming a multi-ply fibrous structure. It is also contemplated that a single fibrous structure can effectively form two “plies” or multiple “plies”, for example, by being folded on itself. In one embodiment, the ply has an end use as a tissue-towel paper product. A ply may comprise one or more wet-laid layers, air-laid layers, and/or combinations thereof. If more than one layer is used, it is not necessary for each layer to be made from the same fibrous structure. Further, the layers may or may not be homogenous within a layer. The actual makeup of a fibrous structure product ply is generally determined by the desired benefits of the final tissue-towel paper product, as would be known to one of skill in the art. The fibrous structure may comprise one or more plies of non-woven materials in addition to the wet-laid and/or air-laid plies.

The term “fibrous structure”, or “paper web” or “web” as used herein, means an arrangement of fibers produced in any papermaking machine known in the art to create a ply of paper. “Fiber” means an elongate particulate having an apparent length exceeding its apparent width. More specifically, and as used herein, fiber refers to such fibers suitable for a papermaking process. The present invention contemplates the use of a variety of paper making fibers, such as, natural fibers, synthetic fibers, as well as any other suitable fibers, starches, and combinations thereof. Paper making fibers useful in the present invention include cellulosic fibers commonly known as wood pulp fibers. Applicable wood pulps include chemical pulps, such as Kraft, sulfite and sulfate pulps; mechanical pulps including groundwood, thermomechanical pulp; chemithermomechanical pulp; chemically modified pulps, and the like. In one embodiment chemical pulps are used in tissue towel embodiments since they are known to those of skill in the art to impart a superior tactical sense of softness to tissue sheets made therefrom. Pulps derived from deciduous trees (hardwood) and/or coniferous trees (softwood) may be utilized herein. Such hardwood and softwood fibers can be blended or deposited in layers to provide a stratified web. Exemplary layering embodiments and processes of layering are disclosed in U.S. Pat. Nos. 3,994,771 and 4,300,981. Additionally, fibers derived from non-wood pulp such as cotton linters, bagesse, and the like, may be used. Additionally, fibers derived from recycled paper, which may contain any or all of the pulp categories listed above, as well as other non-fibrous materials such as fillers and adhesives used to manufacture the original paper product may be used in the present invention. In addition, fibers and/or filaments made from polymers, specifically hydroxyl polymers, may be used in the present invention. Non-limiting examples of suitable hydroxyl polymers include polyvinyl alcohol, starch, starch derivatives, chitosan, chitosan derivatives, cellulose derivatives, gums, arabinans, galactans, and combinations thereof. Additionally, other synthetic fibers such as rayon, lyocel, polyester, polyethylene, and polypropylene fibers can be used within the scope of the present invention. Further, such fibers may be latex bonded. Other materials are also intended to be within the scope of the present invention as long as they do not interfere or counter act any advantage presented by the instant invention.

“Basis Weight”, as used herein, is the weight per unit area of a sample reported in lbs/3000 ft² or g/m².

“Machine Direction” or “MD”, as used herein, means the direction parallel to the flow of the fibrous structure through the papermaking machine and/or product manufacturing equipment.

“Cross Machine Direction” or “CD”, as used herein, means the direction perpendicular to the machine direction in the same plane of the fibrous structure and/or fibrous structure product comprising the fibrous structure.

“Differential density”, as used herein, means a portion of a fibrous structure product that is characterized by having a relatively high-bulk field of relatively low fiber density and an array of densified zones of relatively high fiber density. The high-bulk field is alternatively characterized as a field of pillow regions. The densified zones are alternatively referred to as knuckle regions. The densified zones may be discretely spaced within the high-bulk field or may be interconnected, either fully or partially, within the high-bulk field. One embodiment of a method of making a differential density fibrous structure and devices used therein are described in U.S. Pat. Nos. 4,529,480 and 4,528,239.

“Densified”, as used herein means a portion of a fibrous structure product that is characterized by zones of relatively high fiber density. The densified zones are alternatively known as “knuckle regions”. The densified zones may be discretely spaced within the high-bulk field or may be interconnected, either fully or partially, within the high bulk field.

“Non-densified”, as used herein, means a portion of a fibrous structure product that exhibits a lesser density than another portion of the fibrous structure product. The non-densified zones are alternatively known as “pillow regions”.

“Macrofolding” as used herein, is defined as causing a low-fiber-consistency web to fold in such a manner that adjacent MD spaced portions of the web become stacked on each other in the Z-direction of the web.

“Wet-microcontracting”, as used herein, is wet-end machine-direction-foreshortening which is effected in such a manner that macrofolding is substantially precluded. In one embodiment, the present invention relates to a process for making a fibrous structure product having high bulk, a wet strength substantially higher than comparably extensible dry-creped paper, and/or improved absorbency. These advantages are achieved by forming a paper web from an aqueous fibrous papermaking furnish, and non-compressively removing sufficient water therefrom prior to its reaching a transfer zone on a carrier fabric. In one embodiment the paper web has a predetermined fiber consistency at the transfer zone. The consistency prior to the transfer, in one embodiment, is from about 10% to about 30% fibers by weight and, in another embodiment from about 15% to about 28% fibers by weight and, and in yet another embodiment from about 20% to about 25% fibers by weight. Dry and/or wet strength additives may be included in the furnish or applied to the web after its formation to impart a predetermined level of strength to the web. In one embodiment at the transfer zone, the back side of a transfer/imprinting (i.e., receiving) fabric traverses a convexly curved transfer head, wherein while the transfer/imprinting fabric is traversing the transfer head, the carrier fabric is caused to converge and then diverge therewith at sufficiently small acute angles that compaction or densification of the web therebetween is substantially obviated.

The transfer/imprinting fabric may have a substantial void volume, and is forwarded at a second velocity (V₂) which is slower than the first velocity (V₁) of the carrier fabric. In one embodiment V₂ is from about 10% to about 40% slower, in another embodiment from about 15% to about 30% slower, and in another embodiment from about 18% to about 25% slower than V₁.

In one embodiment, at the transfer zone, only a sufficient differential gaseous pressure vacuum is applied through the transfer head, to the web to cause it to transfer to the transfer/imprinting fabric without substantial compaction: i.e., without a substantial increase in its density. The web is thereafter dried without overall compaction or densification thereof and without substantially altering the macroscopic fiber arrangement in the plane of the web. In one embodiment, the web is imprinted with the knuckle pattern of the transfer fabric under high pressure to precipitate tensile strength bonds, and the web may be sufficiently dry-creped to substantially reduce any harshness which might otherwise be precipitated by such imprinting. The web may then be lightly calendered for caliper control and reeled or directly converted to paper products. In one embodiment the reel is operated at a forth velocity (V₄) which is faster than the third velocity (V₃) speed of the drying-creping cylinder. In one embodiment V₄ is from about 1% to about 10% faster, in another embodiment from about 1.5% to about 8% faster than V₃.

### DETAILED DESCRIPTION OF THE INVENTION

Briefly, in one embodiment, the process of the present invention involves the formation of a paper web from an aqueous slurry of papermaking fibers. The web is forwarded at a low fiber consistency on a foraminous member to a differential velocity transfer zone where the web is transferred to a slower moving transfer/imprinting fabric, such as a loop of open weave fabric, to achieve wet-microcontraction of the web in the machine direction without precipitating substantial macrofolding (defined herein) or compaction of the web. After the differential velocity transfer, the web is dried without overall compaction and without significant material rearrangement of the fibers of the web in the plane thereof. The paper may exhibit differential density and be pattern compacted by imprinting a fabric knuckle pattern of the transfer/imprinting fabric into it prior to final drying. The paper web may be creped after being dried. Also, primarily for product caliper control, the paper may be lightly calendered after being dried. The differential velocity transfer is achieved without precipitating substantial compaction (i.e., densification) of the web. The impact angle I of the creping blade is also optimized. The reeling of the web is accomplished at a forth velocity that is faster than the third velocity of the drying cylinder. Thus, the web is said to be wet-microcontracted as opposed to being wet-compacted or macro-folded or the like.

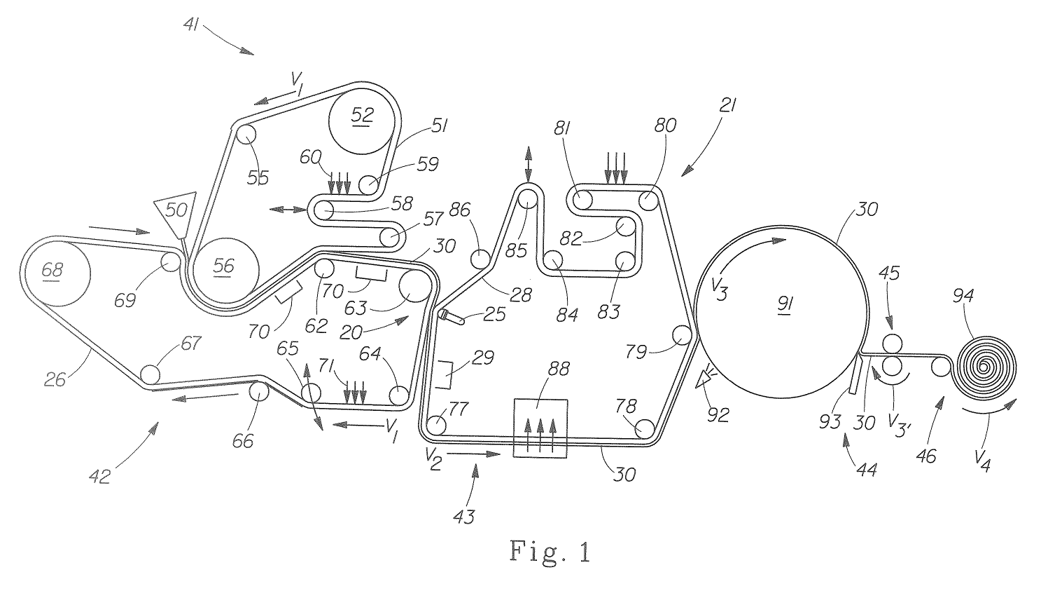

FIG. 1 shows, in somewhat schematic form, an exemplary papermaking machine 21 for practicing the present invention. Papermaking machine 21 comprises transfer zone 20 as described herein and, additionally: a forming section 41, an intermediate carrier section 42, a pre-dryer/imprinting section 43, a drying/creping section 44, a calendar assembly 45, and reel 46.

The forming section 41 of FIG. 1, of papermaking machine 21 comprises a headbox 50; a loop of fine mesh backing wire or fabric 51 which is looped about a vacuum breast roll 52, over vacuum box 70, about rolls 55 through 59, and under showers 60. Intermediate rolls 56 and 57, backing wire/fabric 51 is deflected from a straight run by a separation roll 62. Biasing means not shown are provided for moving roll 58 as indicated by the adjacent arrow to maintain fabric/wire 51 in a slack obviating tensioned state.

Intermediate carrier section 42, FIG. 1, comprises a loop of carrier fabric 26 which is looped about rolls 62 through 69 and about an arcuate portion of roll 56. The carrier fabric 26 also passes over vacuum boxes 70 and 53, and transfer head 25; and under showers 71. Biasing means are also provided to move roll 65 to obviate slack in fabric 26. As is clearly indicated in FIG. 1, juxtaposed portions of fabrics 51 and 26 extend about an arcuate portion of roll 56, across vacuum box 70, and separate after passing over an arcuate portion of separation roll 62. In one embodiment, carrier fabric 26 is identical to backing wire/fabric 51 except for their lengths.

The pre-dryer/imprinting section 43, FIG. 1, of papermaking machine 21 comprises a loop of transfer/imprinting fabric 28. Transfer/imprinting fabric 28 is looped about rolls 77 through 86; passes across transfer head 25 and vacuum box 29; through a blow-through pre-dryer 88; and under showers 89. Additionally, in one embodiment, is a biasing mechanism for biasing roll 79 towards the adjacent drying/creping cylinder 91 with a predetermined force per lineal inch (pli) to effect imprinting the knuckle pattern of fabric 28 in web 30 in the manner of and for the purpose disclosed in U.S. Pat. No. 3,301,746, issued Jan. 31, 1967, Sanford and Sisson. In one embodiment a biasing mechanism is used for moving roll 85 as indicated by the adjacent arrow to obviate slack in fabric 28.

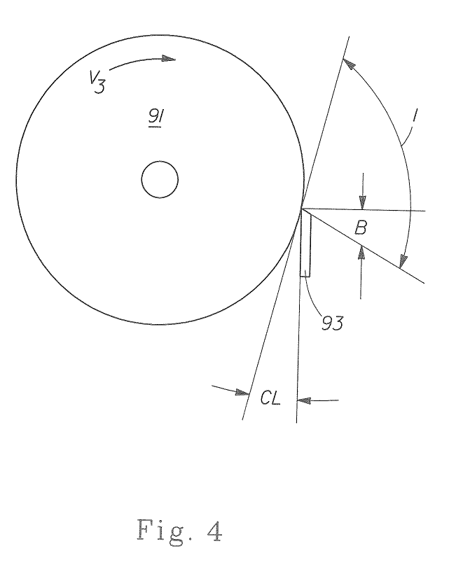

The drying/creping section 44, FIG. 1, of papermaking machine 21 comprises drying or drying cylinder 91, adhesive applicator 92, and doctor blade 93. This portion of papermaking machine is shown in somewhat larger scale in FIG. 4 in order to clearly define certain angles with respect to the doctor blade 93 and its relation to drying cylinder 91. Accordingly, drying/creping section 44 is described more fully herein concomitantly with discussing FIG. 4.

FIG. 1 further comprises velocity control mechanisms for independently controlling the velocities V1 (of carrier fabric 26), V2 (of transfer/imprinting fabric 28), V3 (of drying cylinder 91), V3′ (of calendar assembly), and V4 (of reel) in order to independently control the degree of wet-microcontraction precipitated in the transfer zone 20, the degree of dry-crepe, and the degree of residual dry-crepe as is more fully described herein.

FIG. 4 is an enlarged scale view of the creping section of papermaking machine 21 in which the impact angle between drying cylinder 91 and doctor blade 93 is designated angle I, the bevel angle of doctor blade 93 is designated angle B, and the back clearance angle between drying cylinder 91 and doctor blade 93 is designate angle CL. In general, creping of a paper web tends to disrupt bonds in the web. Generally, this causes the web to be softer but of lower tensile strength than if it were not creped. In some instances increasing angle I may lessen the softening induced by creping and may generally lessen the creping induced reduction of tensile strength.

Therefore in one embodiment, the present process relates to the proper combination and optimization of these parameters: the angle I, the velocity of the carrier fabric relative to the transfer/imprinting fabric, the reel velocity relative to the dryer/creping cylinder, and the selection of specific embodiments of the transfer/imprinting fabric. The careful control and combination of these parameters, results in a fibrous structure product having high bulk, a wet strength substantially higher from comparably extensible dry-creped paper, improved absorbency, and acceptable tensile. Careful optimization of these parameters is important since wet-microcontracting may precipitate lower tensile strength and less softness but better dry end sheet control than dry-creping to achieve equally MD foreshortened paper webs, all other factors being equal. Decreasing the angle I may improve softening but degrade tensile.

In one embodiment, I is from about 90 degrees to about 130 degrees, in another embodiment from about 92 degrees to about 120 degrees, and in another embodiment from about 93 degrees to about 115 degrees. In one embodiment angle B is from about 35 degrees to about 75 degrees and/or from about 40 degrees to about 70 degrees, and/or from about 45 degrees to about 65 degrees.

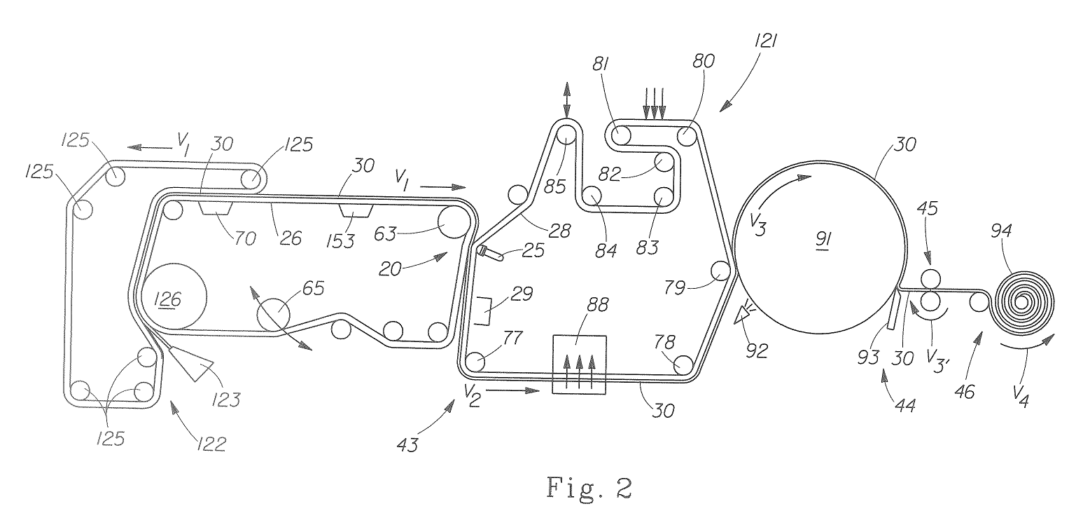

FIG. 2 shows an alternate twin-wire-former (TWF) type papermaking machine 121 with which the present process invention may be practiced to produce paper of the present invention. As compared to papermaking machine 21, FIG. 1, papermaking machine 121 comprises a so-called C-wrap twin-wire-former section 122 rather than an S-wrap twin-wire-former. Insofar as the present invention is concerned, the transfer zone 20 of both machines are, in one embodiment, identical, as are their pre-dryer/imprinting sections 43, their drying/creping sections 44, their calender assembly 45, and their reel 46. Thus, these sections and their corresponding components are identically numbered albeit some of the components numbered in FIG. 1 are not numbered in FIG. 2 to avoid undue redundancy.

The twin-wire-former section 122 of papermaking machine 121, FIG. 2, comprises an endless foraminous forming wire/fabric 127 which is looped about a plurality of guide rolls 125; and an endless, foraminous backing and/or carrier fabric 26 which is looped about the forming roll 126 and through the transfer zone 20 as shown. Essentially, fabrics 26 and 127 synchronously converge adjacent a headbox 123 from which a jet of aqueous papermaking furnish issues. Primary dewatering occurs through the portion of fabric 127 wrapped about forming roll 126, and subsequent dewatering is assisted by transfer vacuum box 70 and vacuum box 153 to provide a predetermined fiber consistency of the web 30 as it is forwarded on carrier fabric 26 to the transfer zone 20. In one embodiment, papermaking machine 121 is operated like papermaking machine 21, FIG. 1. It is not intended, however, to thereby imply that the present invention is limited to papermaking machines having identical transfer zones.

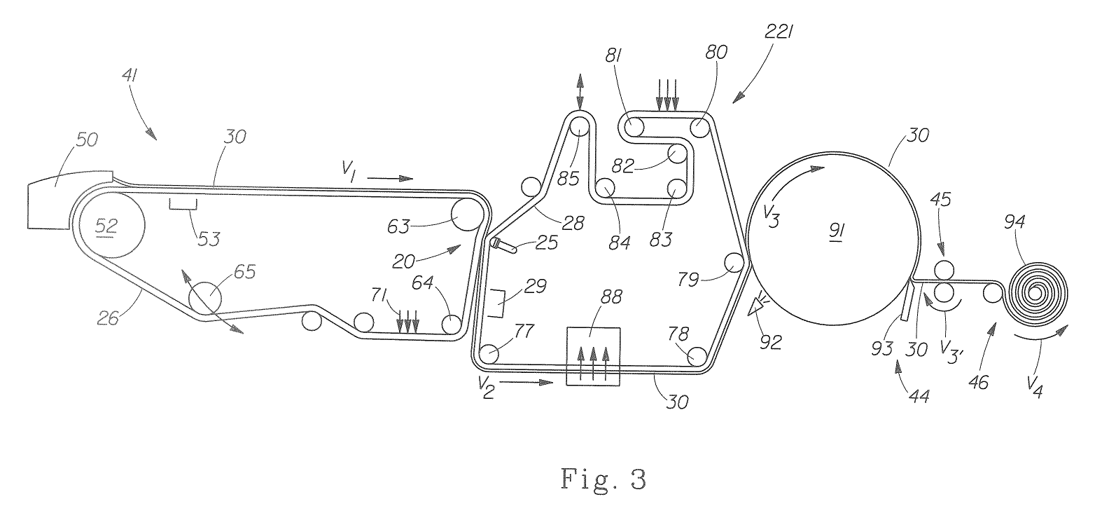

FIG. 3 is a side elevational view of another papermaking machine 221 in which the present invention may be practiced, and in which the corresponding elements are identically designated to the elements of papermaking machine 21, FIG. 1. In one embodiment, papermaking machine 221 is operated in the same manner as papermaking machine 21: that is, the paper web 30 undergoes a differential velocity, relatively non-compacting transfer from carrier fabric 26 to transfer/imprinting fabric 28 while the fiber consistency of the web is relatively low. The low fiber consistency and the relative absence of compacting forces enables substantial machine-direction foreshortening of the web without substantial compaction or densification of the web.

### Carrier and Transfer/Imprinting Fabrics

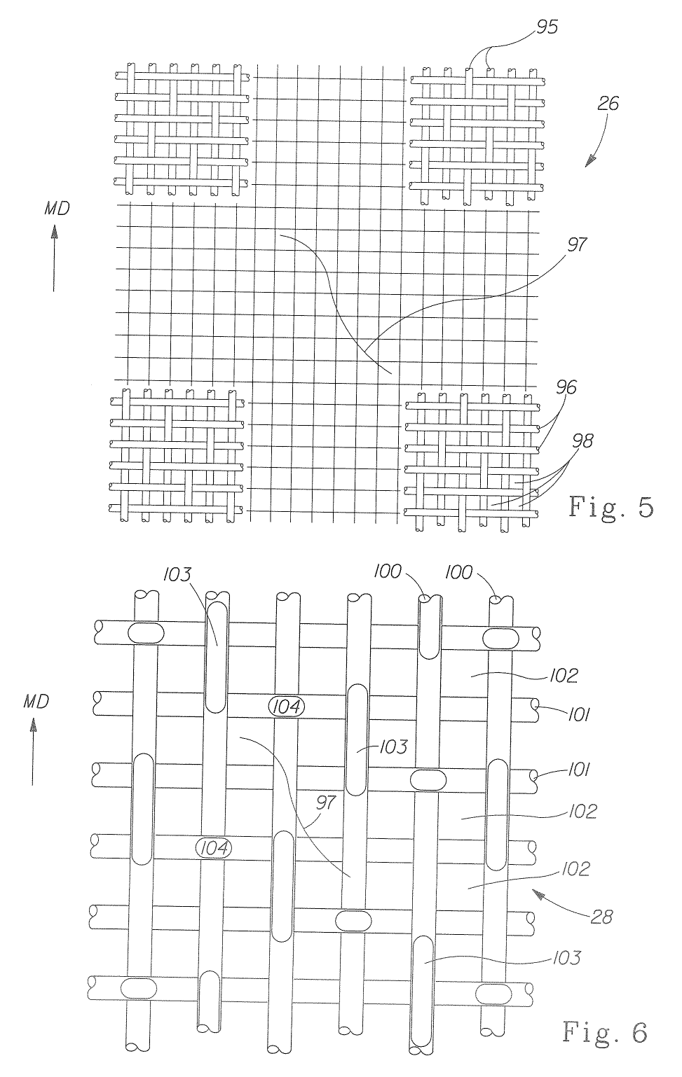

FIG. 5 is an enlarged scale fragmentary plan view of one embodiment of the carrier fabric 26 and of the backing wire or fabric 51 of papermaking machine 21, FIG. 1. These may be selected from those disclosed in U.S. Pat. No. 4,440,597, issued Apr. 3, 1984, Wells and Hensler. The carrier fabric 26 shown in FIG. 5 comprises machine direction filaments 95 and cross-machine-direction filaments 96 which are woven together in a 5-shed satin weave using a non-numerically-consecutive warp pick sequence. This forms an open weave fabric having apertures 98. Such a fabric weave is further described in U.S. Pat. No. 4,239,065 and shown in FIG. 8 thereof. Filaments 95 and 96 are, in one embodiment, polyester monofilaments. A typical papermaking fiber 97 having an approximate length of about two mm is shown superimposed on an exemplary carrier fabric 26 having a mesh count of eighty-four machine direction filaments per inch (about 33 MD filaments per centimeter) and seventy-six cross-machine direction filaments per inch (about 30 CD filaments per centimeter). All of the filaments of the exemplary carrier fabric 26 have nominal diameters of about seventeen-hundredths mm. Thus, papermaking fibers tend to lie substantially flat on such a fine mesh fabric when it is used as either a forming fabric or an intermediate carrier fabric; and apertures 98 facilitate water drainage as well as water removal via vacuum means.

A variety of transfer/imprinting fabrics may be used herein. For example, FIG. 6 is a fragmentary plan view of an exemplary transfer/imprinting fabric 28 of papermaking machine 21, FIG. 1. The scale of FIG. 6 is about the same as for FIG. 5 in order to clearly illustrate the relatively large apertures 102 (void spaces) of fabric 28 compared to the size of papermaking fiber 97, and thus make it readily apparent that such fibers can be deflected into the voids of such a coarse mesh, open weave transfer fabric. For instance, as shown, fabric 28 has a mesh count of about twenty-four machine direction filaments 100 per inch (about 9.5 MD filaments per centimeter) and about twenty cross-machine direction filaments 101 per inch (about 7.9 CD filaments per centimeter). The filaments 100 and 101 of the exemplary transfer fabric 28 are, in one embodiment, polyester, and have diameters of about six-tenths of a millimeter. As shown, transfer fabric 28 is also an open, 5-shed satin weave generated by using a normumerically-consecutive warp pick sequence (e.g., 1, 3, 5, 2, 4) as described in U.S. Pat. No. 4,239,065; and the top surface of fabric 28 has been sanded to provide flat eliptical-shape imprinting knuckles designated 103 and 104.

In another embodiment the transfer/imprinting fabric 28, may have a mesh count of thirty-six MD filaments per inch (about 14/cm) by thirty-two CD filaments per inch (about 12.6/cm) or having a mesh count of sixty-four MD filaments per inch (about 25.2/cm) by fifty-four CD filaments per inch (about 21.3/cm).

In one embodiment the transfer/imprinting fabric has a sufficient void volume by virtue of being an open weave and having a mesh count of from about four to about thirty filaments per centimeter in both the machine direction and the cross-machine direction and, in another embodiment, from about six to about twenty-six filaments per centimeter in both directions and, in another embodiment, from about six to about fifteen filaments per centimeter in both directions.

In another embodiment the transfer/imprinting fabric comprises:

an X-Y plane, and a thickness extending in a Z-direction perpendicular to the X-Y plane;

a framework comprising:

a first layer and a second layer, each of the first and second layers having a top surface, a bottom surface opposite to the top surface, and the first layer having a plurality of deflection conduits extending in the Z-direction between the top and bottom surfaces of the first layer and structured to receive therein fibers of the fibrous structure; the first layer comprising a substantially continuous, substantially discontinous or substantially semicontinuous patterned network;

wherein the second layer comprises a plurality of discrete protuberances; and the top surface of the second layer forming the web-side of the framework;

a reinforcing element comprising:

a paper facing side and a machine facing side opposite to the paper facing side.

In one embodiment the second layer at least partially penetrates at least some of the reinforcing element and/or the bottom surface of the second layer is coplanar with the bottom surface of the first layer.

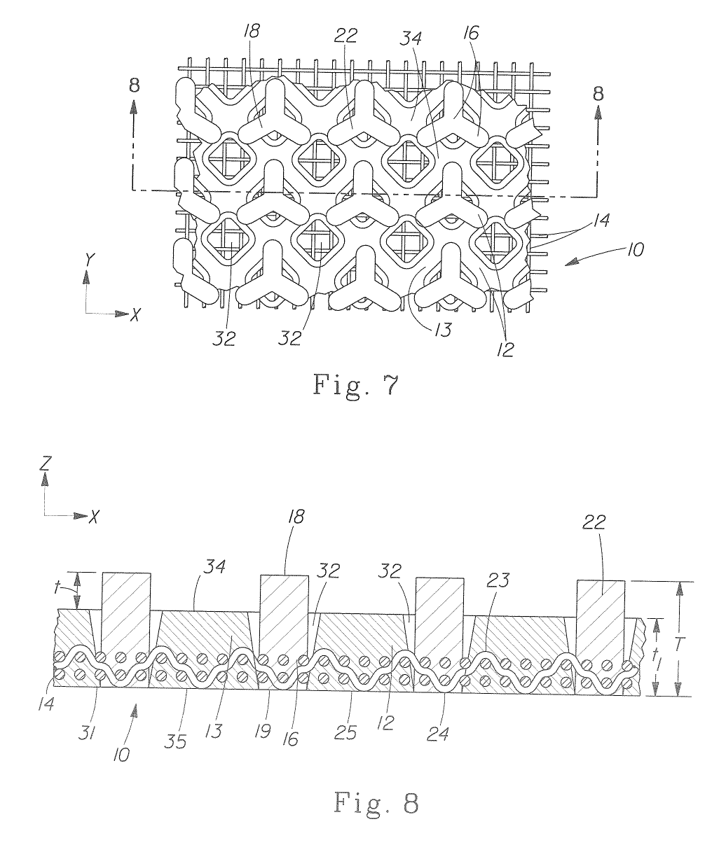

Referring to FIGS. 7-10, the transfer/imprinting fabric 10 is useful for the papermaking process herein. The transfer/imprinting fabric 10 may be used as a through air drying belt, a forming fabric, a backing wire for a twin wire former, a transfer fabric, or, with appropriate batting, as a press felt, etc. Except as noted, the following discussion is directed to a through air drying belt.

In one embodiment the first layer 13 and the second layer 16 of the transfer/imprinting fabric 10 are macroscopically monoplanar and/or non-monoplanar. The plane of the transfer/imprinting fabric 10 defines the X-Y directions. Perpendicular to the X-Y directions and the plane of the transfer/imprinting fabric 10 is the Z-direction of the transfer/imprinting fabric 10. The thickness of the transfer/imprinting fabric 10, “T”, is from about 15 mils to about 100 mils, in another embodiment from about 25 mils to about 60 mils.

The transfer/imprinting fabric 10 may comprise two primary components: a framework 12 and a reinforcing element 14. The framework 12 may comprise any suitable material, including, without limitation, a resinous material (such as, for example, a photosensitive resin), plastic, metal, metal-impregnated polymers, molded or extruded thermoplastic or pseudo-thermoplastic material, and in one embodiment comprises a cured polymeric photosensitive resin. If a photosensitive resin is used, in one embodiment the resin, when cured, should have a hardness of no more than about 60 Shore D. The hardness is measured on an unpatterned photopolymer resin coupon measuring about 1 inch by 2 inches by 0.025 inches thick cured under the same conditions as the framework. The hardness measurement is made at 85 degrees Centigrade and read 10 seconds after initial engagement of the Shore D durometer probe with the resin. Suitable photosensitive resins include polymers which cure or cross-link under the influence of radiation, e.g. see U.S. Pat. No. 4,514,345 issued Apr. 30, 1985 to Johnson et al.

The framework 12 has a first layer 13 and a second layer 16. The first layer 13 has a top surface 34 and a bottom surface 35. The second layer 16 also has a top surface 18 and a bottom surface 19. In one embodiment the top surface 34 of the first layer 13 and the top surface 18 of the second layer 16 defines the paper contacting side of the transfer/imprinting fabric 10 and an opposed backside 25 of the framework 12 oriented towards the papermaking machine on which the transfer/imprinting fabric 10 is used. In one embodiment the second layer 16 extends above the top surface 34 of the first layer 13 a distance of “t”, which is from about 5 mils to about 40 mils, in another embodiment from about 10 mils to about 30 mils, and in another embodiment from about 15 mils to about 25 mils. The thickness of the first layer (t₁) is from about 10 mils to about 60 mils, in another embodiment from about 15 mils to about 40 mils, and in another embodiment from about 30 mils to about 40 mils.

The first layer 13 and the second layer 16 of the framework 12, in one embodiment, defines the paper contacting side of the transfer/imprinting fabric 10. In one embodiment the framework 12 defines a predetermined pattern, which imprints a like pattern onto the paper made therefrom. Discrete islolated deflection conduits 32 extend between the a top surface 34 and a bottom surface 35 of the first layer 13.

Extending in the Z direction above the top surface 34 of the first layer 16 of the transfer/imprinting fabric 10, are a plurality of discrete protuberances 22 forming the second layer 16. The discrete protuberances 22 may be of any shape or size. In one embodiment the discrete protuberances 22 of the second layer comprise closed figures at a frequency of from about 10/inch² to about 250/in², in another embodiment from about 20/inch² to about 100/in². The top surface 18 of the second layer 16 comprises a surface area of from about 10% to about 45%, in another embodiment from about 15% to about 35%, in another embodiment from about 20% to about 30%, of the total surface area of the reinforcing element. The total projected (paper contacting) surface area of the top surfaces of the first layer 13 and second layer 16 is from about 10% to about 80%, in another embodiment from about 15% to about 55%, and in another embodiment from about 20% to about 45%, of the total surface area of the reinforcing element.

The machine side 31 of the transfer/imprinting fabric 10 may be either the machine facing side 24 of the reinforcing element 14, the bottom surface 35 of the first layer 13 and/or the bottom surface 19 of the second layer 16, or combinations thereof. The machine facing side 24 of the reinforcing element 14 is, in one embodiment, the machine contacting surface of the transfer/imprinting fabric 10. The reinforcing element 14 may have a network with passageways therein which are distinct from the deflection conduits. The passageways of the reinforcing element 14 may provide irregularities in the texture of the backside of the transfer/imprinting fabric 10. These irregularities allow for air leakage in the X-Y plane of the transfer/imprinting fabric 10, which leakage does not necessarily flow in the Z-direction through the deflection conduits of the transfer/imprinting fabric 10.

The reinforcing element 14, like the framework 12, has a paper facing side 23 and a machine facing side 24 that is opposite the paper facing side. The reinforcing element 14 may be primarily disposed between the opposed surfaces of the transfer/imprinting fabric 10 and may have a surface coincident the backside of the transfer/imprinting fabric 10. The reinforcing element 14 provides support for the framework 12.

In one embodiment the reinforcing element 14 is woven. In addition to woven fabric, the reinforcing element 14, may be a nonwoven element, wire mesh, screen, net, press felt or a plate or film having a plurality of holes therethrough or other material that may provide adequate support and strength for the framework 12 of the present invention. Suitable reinforcing elements 14 may be made according to commonly assigned U.S. Pat. No. 5,496,624, issued Mar. 5, 1996 to Stelljes, et al., U.S. Pat. No. 5,500,277 issued Mar. 19, 1996 to Trokhan et al., and U.S. Pat. No. 5,566,724 issued Oct. 22, 1996 to Trokhan et al. The reinforcing element 14 may be fluid-permeable, fluid-impermeable, or partially fluid-permeable (meaning that some portions of the reinforcing element may be fluid-permeable, while other portions thereof may be not).

In one embodiment, the reinforcing element has a thickness of from about 10 mils to about 50 mils. In one embodiment, the reinforcing element has a thickness of from about 26 mils to about 30 mils when t₁ is from about 13 mils to about 34 mils. In another embodiment, the reinforcing element has a thickness of from about 38 mils to about 42 mils when t₁ is from about 19 mils to about 46 mils.

Portions of the reinforcing element 14 may be registered with the deflection conduits to prevent fibers used in papermaking from passing completely through the deflection conduits, and thereby reduce the occurrences of pinholes in the paper made therewith.

As shown in FIGS. 7-8, in one embodiment of the present invention, the framework 12 comprises a first layer 13 comprising a substantially continuous patterned network defining a plurality of discrete isolated deflection conduits 32 therewithin. The first layer 13 borders and defines the discrete isolated deflection conduits 32 (also referred to as discontinuous deflection conduits). The perimeter of each of the discrete isolated deflection conduit 32 may define a polygon wherein the deflection conduits 32 are distributed in a repeating array. In one embodiment the polygon has less than seven sides, in another embodiment has less than 6 sides. In one embodiment the polygons have a frequency of from about 10/inch² to about 250/in², in another embodiment from about 50/inch² to about 150/in². In one embodiment the repeating array is a bilaterally staggered array. The second layer 16 may fully penetrate at least some of the reinforcing element 14, around the first layer 13. Extending in the Z direction above the top surface 34 of the first layer 13 of the transfer/imprinting fabric 10, are a plurality of discrete protuberances 22. FIG. 8 is an offset vertical sectional view of the fabric of FIG. 7 taken along lines 8-8, where the second layer 16 completely penetrates the reinforcing element 14.

In one embodiment the surface area of the top surface 18 of discrete protuberances 22, is between about 5% and about 50%, in another embodiment from about 10% to about 40%, and in another embodiment from about 15% to about 25% of the surface area of the reinforcing element.

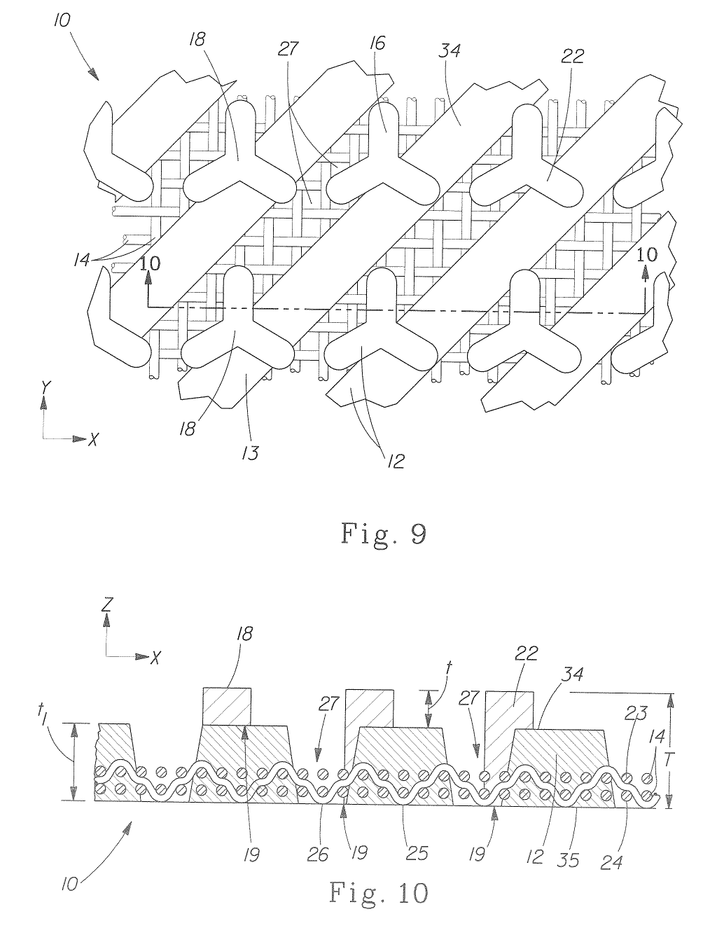

As shown in FIGS. 9-10, in one embodiment of the present invention, the framework 12 comprises a first layer 13 comprising a substantially semi-continuous patterned network defining a plurality of semi-continuous deflection conduits 27 therewithin. The first layer 13 borders and defines the semi-continuous deflection conduits 27. The second layer 16 fully penetrates at least some of the reinforcing element 14 around the first layer 13. Extending in the Z direction above the top surface 34 of the first layer 13 of the fabric 10, are a plurality of discrete protuberances 22. FIG. 10 is an offset vertical sectional view of the transfer/imprinting fabric of FIG. 9 taken along lines 10-10, where the second layer 16 completely penetrates at least some of the reinforcing element 14.

The transfer/imprinting fabric, in one embodiment, has an air permeability of between about 200 and about 800 standard cubic feet per minute (scfm), where the air permeability in scfm is a measure of the number of cubic feet of air per minute that pass through a one square foot area of the transfer/imprinting fabric at a pressure drop across the thickness of the transfer/imprinting fabric 10 equal to about 0.5 inch of water. The air permeability may be measured using a Valmet permeability measuring device (Model Wigo Taifun Type 1000) available from the Valmet Corporation of Pansio, Finland.

In one embodiment the transfer/imprinting fabric has the air permeability listed above so that the fabric may be used with a paper making machine having a vacuum transfer section and a through air drying capability, as described herein.

The reinforcing element 14, in one embodiment, has between about 25 filaments and about 100 filaments per inch measured in the cross machine direction and between about 25 filaments and about 100 filaments per inch measured in the machine direction, where the filaments have, in one embodiment, a diameter between about 0.1 millimeter and about 0.5 millimeter, in another embodiment between about 0.15 millimeter and about 0.25 millimeter. The reinforcing element in one embodiment comprises between about 625 and about 10,000 discrete web contacting knuckles per square inch of the projected area of the reinforcing element. In one embodiment the reinforcing element has a thickness from about 28 mils to about 40 mils.

The filaments for use in the reinforcing element may be formed from a number of different materials. Suitable filaments and filament weave patterns for forming the reinforcing element are disclosed in U.S. Pat. No. 4,191,609 issued Mar. 4, 1980 to Trokhan, and U.S. Pat. No. 4,239,065 issued Dec. 16, 1980 to Trokhan.

### EXAMPLE

A papermaking machine of the general configuration shown in FIG. 1 and designated therein as papermaking machine 21 is run under the following conditions in accordance with the present invention to produce fibrous structure products of the present invention. The transfer/imprinting fabric comprises that shown in either FIG. 7 or FIG. 9, wherein “T”, is from about 15 mils to about 100 mils, the thickness of the first layer (t₁) is from about 10 mils to about 60 mils, and “t”, which is from about 5 mils to about 40 mils. The framework 12 comprises a photosensitive resin, and the reinforcing element 14 is a fluid-permeable, woven fabric. The discrete protuberances 22 of the second layer comprise closed figures at a frequency of from about 20/inch² to about 100/in². The top surface 18 of the second layer 16 comprises a surface area of from about 10% to about 45%, of the total surface area of the reinforcing element. The reinforcing element 14 is woven. The curvature of surface of transfer head 25 was an eight (8) inch (about 20 cm.) radius. The furnish comprises fifty percent (65%) northern softwood kraft (NSK) (i.e., long papermaking fibers) and fifty percent (35%) chemithermal mechanical pulp. A strength additive, Kymene 557H, is added to the furnish at a rate of about 20 pounds per ton (about 10 gms/kg). Kymene is a registered trademark of Hercules Inc, of Wilmonton, Del. Polyvinyl alcohol creping adhesive is used. An impact angle I of about 110 degrees and angle B of from about 45 degrees to about 65 degrees are maintained. A fiber consistency of about 20% is maintained at the couch roll and a before-pre-dryer (hereinafter BPD) fiber consistency of about 25% is maintained. During the run, a constant velocity V₁ of about six hundred eighty (680) feet per minute is maintained for fabrics 51 and 26; a constant reel velocity V₄ of about four-hundred-fifty (575) feet per minute is maintained; and V₂ is about five-hundred-fifty (550), and V₃ is about five-hundred-sixty (560). Also, the paper web is dried in the pre-dryer 88 to a fiber consistency of from about seventy to about 60% after the pre-dryer (hereinafter APD); and final dried on the Yankee to about 96% to about 98%. The resulting paper has a basis weight of from about 14 to about 18 pounds per three-thousand square feet (from about 23 to about 29 grams per square meter), and a dry caliper of from about 20 mils to about 35 mils.

All measurements referred to herein are made at 23+/−1° C. and 50% relative humidity, unless otherwise specified.

All publications, patent applications, and issued patents mentioned herein are hereby incorporated in their entirety by reference. Citation of any reference is not an admission regarding any determination as to its availability as prior art to the claimed invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process of making a wet-microcontracted fibrous structure product comprising the steps of:
forming an embryonic web from an aqueous fibrous papermaking furnish;
forwarding the web at a first velocity on a carrier fabric to a transfer zone having a transfer/imprinting fabric;
non-compressively removing water from the web to a fiber consistency of from about 10% to about 30%, immediately prior to reaching the transfer zone;
transferring the web to the transfer/imprinting fabric in the transfer zone without precipitating substantial densification of the web;
forwarding, at a second velocity, the transfer/imprinting fabric along a looped path in contacting relation with a transfer head disposed at the transfer zone, the second velocity being from about 5% to about 40% slower than the first velocity;
adhesively securing the web to a drying cylinder having a third velocity;
drying the web;
creping the web from the drying cylinder with a doctor blade, the doctor blade having an impact angle of from about 90 degrees to about 130 degrees; and
reeling the web at a forth velocity that is faster than the third velocity of the drying cylinder.

2. The process of claim 1 wherein the transfer/imprinting fabric comprises: an X-Y plane, and a thickness extending in a Z-direction perpendicular to the X-Y plane;
a framework comprising:
a first layer and a second layer, each of the first and second layers having a top surface, a bottom surface opposite to the top surface, and the first layer having a plurality of deflection conduits extending in the Z-direction between the top and bottom surfaces of the first layer and structured to receive therein fibers of the fibrous structure; the first layer comprising a substantially continuous, substantially discontinous or substantially semicontinuous patterned network; wherein the second layer comprises a plurality of discrete protuberances; and the top surface of the second layer forming the web-side of the framework;
a reinforcing element comprising:
a paper facing side and a machine facing side opposite to the paper facing side.

3. The process of claim 2 wherein the first layer comprises a substantially continuous patterned network defining a plurality of discrete isolated deflection conduits therewithin.

4. The process of claim 2 wherein the first layer comprises a substantially semicontinuous patterned network defining a plurality of semicontinuous deflection conduits therewithin.

5. The process of claim 2 wherein the first layer comprises a substantially discontinous patterned network defining a plurality of continuous deflection conduits therewithin.

6. The process of claim 2 wherein the transfer/imprinting fabric is from about 15 mils to about 100 mils thick.

7. The process of claim 2 wherein the second layer extends above the top surface of the first layer a distance (t) of from about 5 mils to about 40 mils and the thickness of the first layer (t1) is from about 10 mils to about 60 mils.

8. The process of claim 7 wherein t is from about 15 mils to about 25 mils and t1 is from about 30 mils to about 40 mils.

9. The process of claim 1 wherein the doctor blade has an impact angle of from about 92 degrees to about 120 degrees.

10. The process of claim 9 wherein the doctor blade has an impact angle of from about 93 degrees to about 115 degrees.

11. The process of claim 10 wherein the fiber consistency is from about 15% to about 25%.

12. The process of claim 1 wherein the second velocity is from about 15% to about 30% slower than the first velocity.

13. The process of claim 12 wherein the second velocity is from about 18% to about 25% slower than the first velocity.

14. The process of claim 1 wherein the forth velocity is from about 1% to about 10% faster than the third velocity.

15. The process of claim 14 wherein the forth velocity is from about 1.5% to about 8% faster than the third velocity.

16. The process of claim 1 further comprising the step of adding an effective amount of wet strength material in the aqueous fibrous papermaking furnish, adding it discontinuously to the web after its formation; and combinations thereof.

20. The process of claim 1 further comprising applying only a sufficient level of differential gaseous pressure across the web at the transfer zone to transfer the web to the transfer/imprinting fabric in the transfer zone without precipitating substantial densification of the web.

21. The process of claim 1 wherein the bevel angle of the doctor blade is from about 35 degrees to about 75 degrees.

22. The process of claim 21 wherein the bevel angle of the doctor blade is from about 40 degrees to about 70 degrees.
